(19) United States
(12) Patent Application Publication
(10) Pub. No.: US 2026/0045826 A1
(43) Pub. Date: Feb. 12, 2026

(54) POWER FLOW CONTROL USING DIRECT CURRENT-TIED INTERCONNECTIONS WITH UPSTREAM SWITCHES AND ADVANCED CONTROL MECHANISMS

(71) Applicant: Consolidated Edison Company of New York, Inc., New York, NY (US)

(72) Inventors: Christopher Gerard Jones, New York, NY (US); Simon Odie, New York, NY (US); Constantine Spanos, New York, NY (US); Wenzong Wang, Knoxville, TN (US); Mohammad Aminul Huque, Knoxville, TN (US)

(21) Appl. No.: 19/293,050

(22) Filed: Aug. 7, 2025

Related U.S. Application Data
(60) Provisional application No. 63/683,148, filed on Aug. 14, 2024.

(30) Foreign Application Priority Data
Aug. 9, 2024 (GR) 20240100566

(51) Int. Cl. H02J 13/00; H02J 3/00; H02J 3/32

(52) U.S. Cl. CPC H02J 13/00002; H02J 3/0012; H02J 3/32; H02J 13/00001; H02J 13/00036

(57) ABSTRACT

Examples described herein provide a system for controlling power flow in an energy distribution network. The system includes a plurality of inverters, each having an inverter controller associated therewith. The system further includes a utility controller associated with a utility and configured to communicate with at least a subset of the plurality of inverters. The system further includes a customer controller associated with a customer of the utility and configured to communicate with at least the utility controller. The system further includes a direct current (DC) breaker associated with a battery of the customer. The system further includes a DC meter of the customer, the DC meter and the DC breaker each configured to communicate with the utility controller and the customer controller. The utility controller is configured to determine a current operational scenario of the energy distribution network and to control power routing within the energy distribution network.

### CROSS REFERENCE TO RELATED APPLICATIONS

This application claims priority to U.S. Provisional Application Ser. No. 63/683,148 filed on Aug. 14, 2024, and Greek Patent Application Serial No. 20240100566 filed on Aug. 9, 2024, both of which are incorporated herein by reference in their entirety.

### BACKGROUND

The subject disclosure relates to the energy distribution networks and, more particularly, to power flow control using direct current-tied (DC-tied) interconnections with upstream switches and advanced control mechanisms.

An energy distribution network is a system designed to deliver electricity from producers to consumers. This network involves various components and processes to provide for the efficient and reliable supply of electricity. Elements of an energy distribution network can include one or more of the following: power generation, transmission lines, transmission substations, distribution lines, transformers, distribution substations, service lines, meters, and protection and control systems, such as switches and fuses.

Power flow control refers to the management and regulation of the flow of electrical power within an energy distribution network to ensure that electricity is transmitted efficiently, reliably, and safely from producers to consumers. This involves the use of various technologies, strategies, and devices to control the direction, magnitude, and timing of power flows to provide for maintaining the stability, reliability, and efficiency of the energy distribution network.

### SUMMARY

According to an embodiment, system for controlling power flow in an energy distribution network is provided. The system includes a plurality of inverters, each having an inverter controller associated therewith. The system further includes a utility controller associated with a utility and configured to communicate with at least a subset of the plurality of inverters. The system further includes a customer controller associated with a customer of the utility and configured to communicate with at least the utility controller. The system further includes a direct current (DC) breaker associated with a battery of the customer. The system further includes a DC meter of the customer, the DC meter and the DC breaker each configured to communicate with the utility controller and the customer controller. The utility controller is configured to determine a current operational scenario of the energy distribution network and to control power routing within the energy distribution network based at least in part on the current operational scenario.

According to another embodiment, a method for controlling power flow in an energy distribution network is provided. The energy distribution network includes a plurality of inverters connected to a direct current (DC) bus, a battery connected to the DC bus via a DC breaker, and a utility controller in communication with the inverters and the DC breaker. The method includes determining, by the utility controller, a current operational scenario based at least in part on availability of one or more of the inverters and the battery. The method further includes controlling, by the utility controller, power routing within the energy distribution network based at least in part on the current operational scenario. The method further includes regulating, by the utility controller, a voltage of the DC bus based at least in part on the current operational scenario. The method further includes coordinating, by the utility controller, operation of the inverters and the battery to manage power flow in the energy distribution network.

According to yet another embodiment, an energy distribution network is provided that includes a plurality of four-quadrant inverters, each having an inverter controller and being connected to a direct current (DC) bus. The energy distribution network further includes a battery connected to the DC bus via a DC breaker and a DC meter. The energy distribution network further includes a utility controller associated with a utility, the utility controller configured to communicate with at least a subset of the plurality of four-quadrant inverters, the DC breaker, and a DC meter, to determine a current operational scenario of the energy distribution network based at least in part on availability of the four-quadrant inverters and the battery, to control power routing and regulate a voltage of the DC bus based on the current operational scenario, and to coordinate operation of the four-quadrant inverters and the battery to manage power flow within the energy distribution network via optimal power routing for enhanced hosting capacity and improving feeder rating objectives, thereby optimizing performance across the energy distribution network. The energy distribution network further includes a customer controller associated with a customer of the utility, the customer controller configured to communicate with the utility controller, the DC breaker, and the DC meter, to receive battery status information and power requests from the customer, and to relay the battery status information and the power requests to the utility controller. The energy distribution network further includes a tertiary controller configured to communicate with the utility controller and the customer controller, the tertiary controller being operable to issue commands to the utility controller and the customer controller to orchestrate resource operation and optimize system performance across the energy distribution network. The utility controller, the customer controller, and the tertiary controller are configured to coordinate in real time to manage power flow, component availability, and grid conditions within the energy distribution network.

The above features and advantages, and other features and advantages, of the disclosure are readily apparent from the following detailed description when taken in connection with the accompanying drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a block diagram of an energy distribution network according to one or more embodiments;

FIG. 2 is a block diagram of control infrastructure and communication for the energy distribution network of FIG. 1 according to one or more embodiments;

FIG. 3 is a table of operational scenarios for the energy distribution network of FIG. 1 according to one or more embodiments;

FIG. 4 is a block diagram of an operational scenario for the energy distribution network of FIG. 1 according to one or more embodiments;

FIG. 5 is a block diagram of an operational scenario for the energy distribution network of FIG. 1 according to one or more embodiments;

FIG. 6 is a block diagram of an operational scenario for the energy distribution network of FIG. 1 according to one or more embodiments;

FIG. 7 is a block diagram of an operational scenario for the energy distribution network of FIG. 1 according to one or more embodiments;

FIG. 8 is a block diagram of a system for implementing one or more embodiments described herein.

The detailed description explains embodiments of the disclosure, together with advantages and features, by way of example with reference to the drawings.

### DETAILED DESCRIPTION

One or more embodiments described herein relates to power flow control using DC-tied interconnections with upstream switches and advanced control mechanisms. In particular, one or more embodiments provide for integrating sustainable and technologically advanced solutions that satisfy the evolving needs of utility customers and energy distribution networks. Direct current (DC)-tied interconnections can enhance distribution hosting capacity, and improve the resilience and efficiency of pre-existing alternating current (AC) feeder systems, particularly in response to increasing vulnerability from climate change, and the rapid rise of distributed energy resource (DER) interconnections such as solar, wind, battery energy storage systems, and electric vehicles, among others. By modifying the DC infrastructure of a conventional DER interconnection, such as an energy storage system, one or more embodiments provides for power flow control and load management across AC supply feeders.

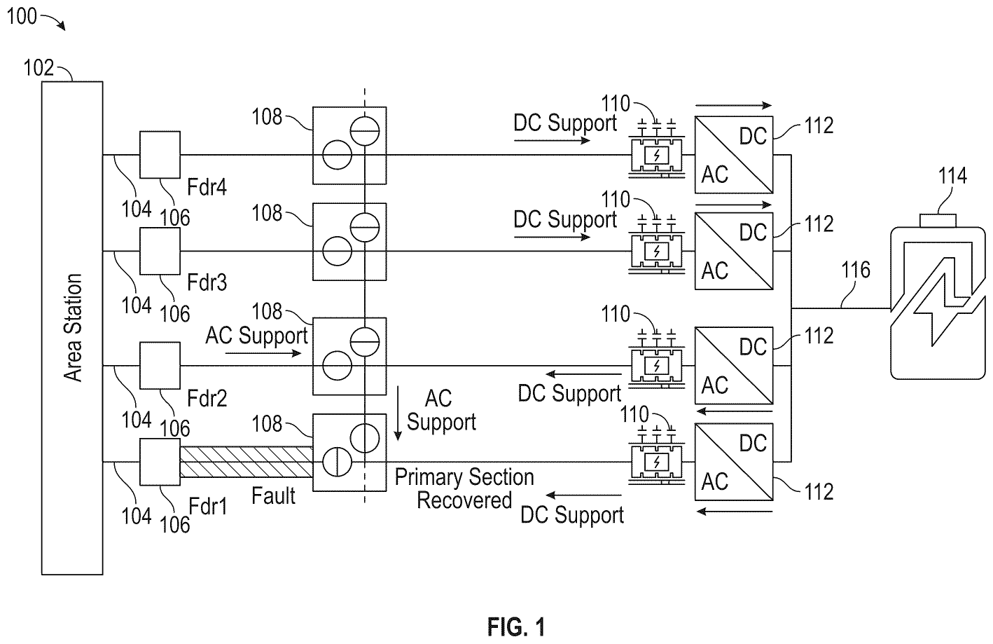

FIG. 1 is a block diagram of an energy distribution network 100 according to one or more embodiments. In the example of FIG. 1, the energy distribution network 100 includes an area station 102 having feeders 104 extending therefrom. The feeders 104 are power lines that transport electricity from the area station 102 to various distribution points along its span, such as a battery 114.

According to one or more embodiments, several components are disposed along the feeders 104 between the area station 102 and the battery 114, including, for example, area station feeder breakers 106, switches 108 (e.g., a vacuum interrupter or recloser), transformers 110, and inverters 112 (e.g., bi-directional AC/DC inverters, four-quadrant bi-directional AC/DC inverters, advanced inverters, smart inverters, and/or the like, including combinations and/or multiples thereof.), configured and arranged as shown.

The area station feeder breakers 106 are circuit breakers that provide protection and control functionality through sectionalization of the feeder. For example, the area station feeder breakers 106 protect components of the energy distribution network 100 along their respective feeders 104. When a fault is detected along one of the feeders 104 extending from the area station 102, the area station feeder breaker associated with that feeder trips, isolating other components along the feeder 104 from the area station 102 to prevent damage to the components and maintain the stability of the energy distribution network 100.

The switches 108 are electrical devices that control the flow of electricity by opening or closing circuits. The switches 108 act to interrupt the flow of electricity, such as when a fault is detected (e.g., a current threshold is reached). When opened, the switches 108 prevent the flow of electricity and act to isolate sections of the power distribution network, which may be useful for maintenance, fault isolation, load management, and/or the like, including combinations and/or multiples thereof. The switches 108 also serve to electrically isolate feeders 104 from one another, which may be asynchronous due to phase angle shifts between them. In an embodiment, the coordinated alteration of switch positions, either through primary controller relays within the switch or via communication with a tertiary controller (such as SCADA) through a transfer trip mechanism, enables the control of power flow to reenergize sections of feeder 104 that were previously de-energized during a fault.

The transformers 110 transfer electrical energy between two circuits (medium and low voltage systems) and can be used to increase (step up) or decrease (step down) voltage levels, and may also provide a low-impedance path to ground to reduce overvoltage during a fault. According to one or more embodiments, for the energy distribution network 100, the transformers 110 can step down the voltage from a higher voltage (e.g., substantially 13 kilowatts (kW)) to a lower voltage (e.g., substantially 480 volts). It should be appreciated that other voltage values can be implemented in other embodiments. It should be appreciated that transformers 110 can be of the following types: a solid-state transformer (SST) or a power electronic transformer (PET), which may include embedded AC-to-DC and/or DC-to-AC stages. Variations of these transformers can directly input or output DC power, providing the equivalent functionality of a conventional power transformer plus inverter in one device, thereby eliminating the need for separate inverters 112.

The inverters 112 convert electricity from alternating current to direct current, and vice versa. The direct current output by the inverters 112 is fed into DC resources, such as a battery 114, via a DC bus 116.

One or more embodiments described herein provide various advantages, such as the following: overcoming the technical challenges of paralleling asynchronous AC feeders due to phase angle differences, and inability to parallel feeders of varying voltage class; allows for dynamic control of feeder capacities through power flow control; facilitates voltage regulation through control of real and reactive power export, alleviates constraints associated with distributed energy resources reverse power flow, increases hosting capacity; enhances grid resiliency, strengthens network dependability during outages and contingencies (e.g. due to additional connections between feeders 104), reduces interconnection costs, and/or the like, including combinations and/or multiples thereof.

One or more embodiments described herein provide for grid management for an energy distribution network that enhances grid resilience during peak demand periods (e.g., during summer months when feeder overloading poses a risk to the energy distribution network). One or more embodiments provide for effectively mitigating feeder overloads by dynamically managing power flows during contingency scenarios.

According to one or more embodiments, as shown in FIG. 1, the energy distribution network 100 is a multi-terminal energy storage system that connects multiple feeders (e.g., the feeders 104) to a shared DC bus (e.g., the DC bus 116) via multiple inverters 112, which may be 4-quadrant AC/DC inverters. Simultaneously, various DC resources such as batteries (e.g., the battery 114), solar photovoltaics (PV) (not shown), and electric vehicles (not shown) can be integrated into or connected to the DC bus 116 to generate electricity and/or provide grid support. In this way, the energy distribution network 100 is versatile, supporting different applications and offering multiple use cases. One particular application is referred to as a “multi-terminal energy storage system” which indicates a configuration where a battery is connected to the DC bus 116 as shown in FIG. 1.

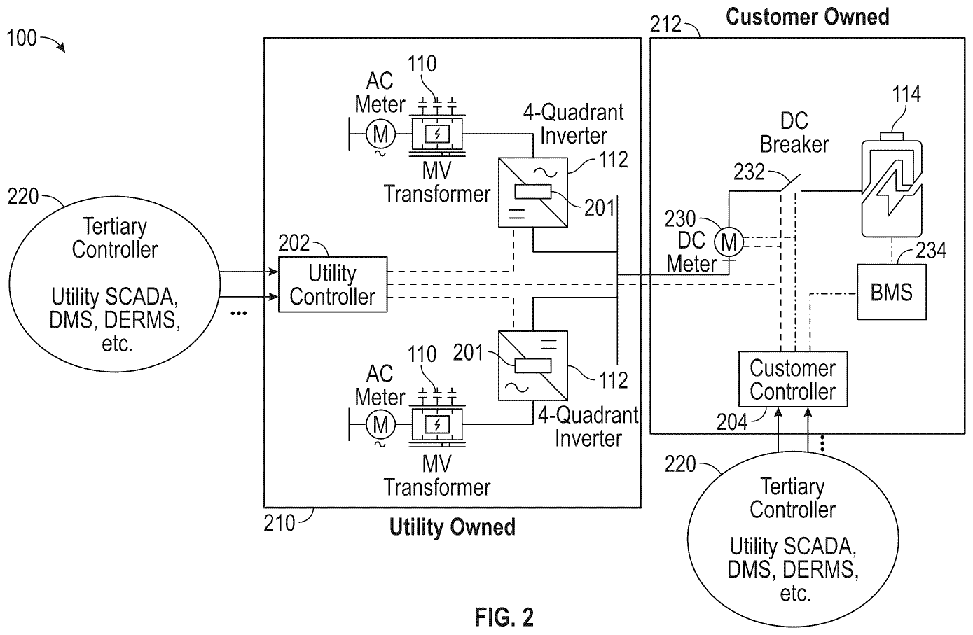

Turning now to FIG. 2, a block diagram of control infrastructure and communication for the energy distribution network 100 of FIG. 1 according to one or more embodiments is shown. In this embodiment, the energy distribution network 100 includes various hardware components, controllers, and communication signals, configured and arranged as shown, which vary depending upon what entity is responsible for (or “owns”) each of the components, controllers, communication signals, and/or the like, including combinations and/or multiples thereof. For example, as shown in FIG. 2, the battery 114 is owned, operated, and maintained by a third-party customer within a customer owned portion 212, the transformers 110 and the inverters 112 can be owned, operated, and maintained by a utility provider (also referred to simply as the “utility”) within a utility owned portion 210. According to one or more embodiments, the inverters 112 may be owned by the customer but are operated by the utility provider for the purposes of power control and/or are controlled by the customer at the direction of the utility provider (e.g., as defined by a contract or agreement between the parties). It should be appreciated that various ownership arrangements could take place other than that depicted, such as an entirely utility owned system. According to one or more embodiments, as shown in FIG. 2, a utility controller 202 is provided to effectively orchestrate power routing within the utility owned portion 210 of the energy distribution network 100, and a customer controller 204 is provided to effectively orchestrate power routing within the customer owned portion 212 of the energy distribution network 100. The utility controller 202 can issue commands to customer-owned distributed energy resource equipment and monitor the status of the upstream grid, including any contingency statuses, for example, by sending and receiving data/commands/signals via the dashed lines extending from the utility controller 202 to the various components as shown. Similarly, the customer controller 204 can send and receive data/commands/signals via the dashed lines extending from the customer controller 204 as shown.

A hierarchical control architecture is provided that includes three control layers that align with the control system time frame and action time domain outlined for microgrid controllers described in IEEE Std 2030.7-2017 (or newer). In particular, the control infrastructure and communication for the energy distribution network 100 utilizes primary control, secondary control, and tertiary control.

Primary control occurs at the inverters 112, switches 108, area station feeder breakers 106, and other elements of the distribution network through internal relays or other embedded programming. For example, the inverters 112 can each include an onboard or integrated controller (referred to as a “primary controller” or “inverter controller”) for regulating the active (P) and reactive (Q) power output (or the DC bus voltage, but not both simultaneously) of the inverters 112. In the example of FIG. 2, the inverters 112 are shown as having inverter controllers 201. Adjustments are based on setpoints received from secondary controllers (as further described herein), or are aligned with internal grid support functions, such as volt-var and frequency-watt. Primary control also encompasses inverter protection and control mechanisms during abnormal external system conditions, such as voltage and frequency ride-through, tripping functions, and anti-islanding measures. The response time for primary control functionality varies, ranging from milliseconds (e.g., overcurrent relaying at feeder breakers 106 and switches 108, or current regulation internal to the inverter) to seconds or tens of seconds (e.g., volt-var, enter service) but may be longer or shorter in various embodiments. In some cases, primary control functions used for the inverters 112 can be met with commercial off-the-shelf products, such as inverters compliant with the latest revision of IEEE 1547. However, primary control functions for the multi-terminal energy storage system as described herein may not be available in all commercial battery inverters.

Secondary control occurs within the utility owned portion 210 (e.g., by the utility controller 202) and within the customer owned portion 212 (e.g., by the customer controller 204). The utility controller 202 and the customer controller are examples of secondary controllers. Secondary controllers receive commands from a higher-level tertiary controller 220 and dispatch setpoints for inverter primary control, for example, based on specific built-in algorithms. The secondary controllers (e.g., the utility controller 202, the customer controller 204) can also manage devices, such as AC or DC circuit breakers. Since the battery 214 in this depiction is owned, operated, and maintained by a customer, the customer uses the customer controller 204 to coordinate with the utility controller 202, as depicted in FIG. 2, to dispatch and oversee the inverters 112. As secondary control functions are tailored to the specific needs of the environment or implementation, the utility controller 202 can be developed and/or customized to meet those needs. The utility controller 202, according to an embodiment, is central to optimal operation of the multi-terminal energy storage system (e.g., the energy distribution network 100), and is described in more detail herein. The response time for secondary control functions typically ranges from seconds to minutes but may be longer or shorter in various embodiments.

Tertiary controllers, such as the tertiary controller 220, issue commands to disparate secondary controllers (e.g., the utility controller 202, the customer controller 204) of various resources within the energy distribution network 100, aiming to orchestrate resource operation and optimize system performance. The complexity of controls for implementing a tertiary controller, such as the tertiary controller 220, depends upon how the tertiary controller is implemented. For example, the tertiary controller 220 can be implemented via the utility's supervisory control and data acquisition (SCADA) system, a distribution management system (DMS), and/or a distributed energy resource management system (DERMS). These operations may occur on a time scale ranging from minutes to hours but can be longer or shorter in various embodiments.

With continued reference to FIG. 2, as illustrated, communication is provided between the tertiary controller 220 (e.g., SCADA) and the secondary controllers (e.g., the utility controller 202 and the customer controller). Communication is also provided between the utility controller 202 and the customer controller, as well as between the utility controller 206 and primary controllers (e.g., inverter controllers 201) associated with the inverter controllers. Also, communication between the secondary controllers and a DC meter 230 and a DC breaker 232 is provided. One or more embodiments provide for minimizing latency between the utility controller 202 and the customer controller 204 to provide efficient operation, enabling interfacing and communication via distributed network protocol 3 (DNP3) SCADA protocols, and equipping controllers with an independent backup power supply to provide continuity of service and maintain plant status. The specifics of information exchange among these components are described further herein.

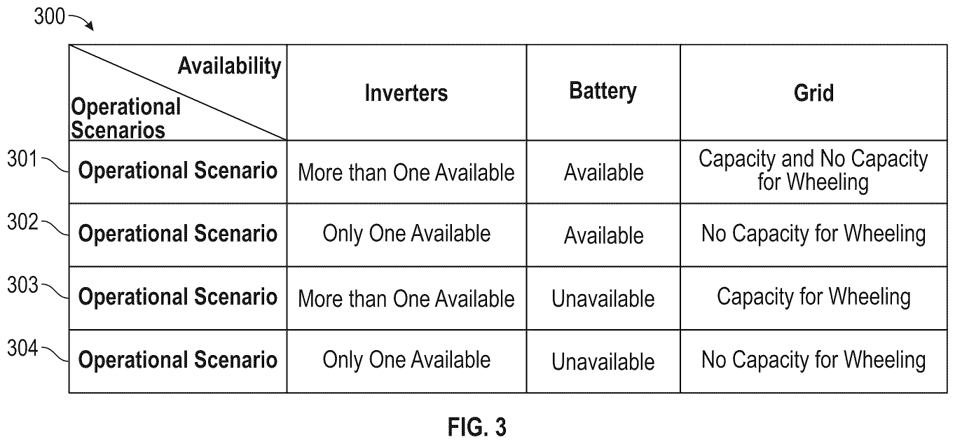

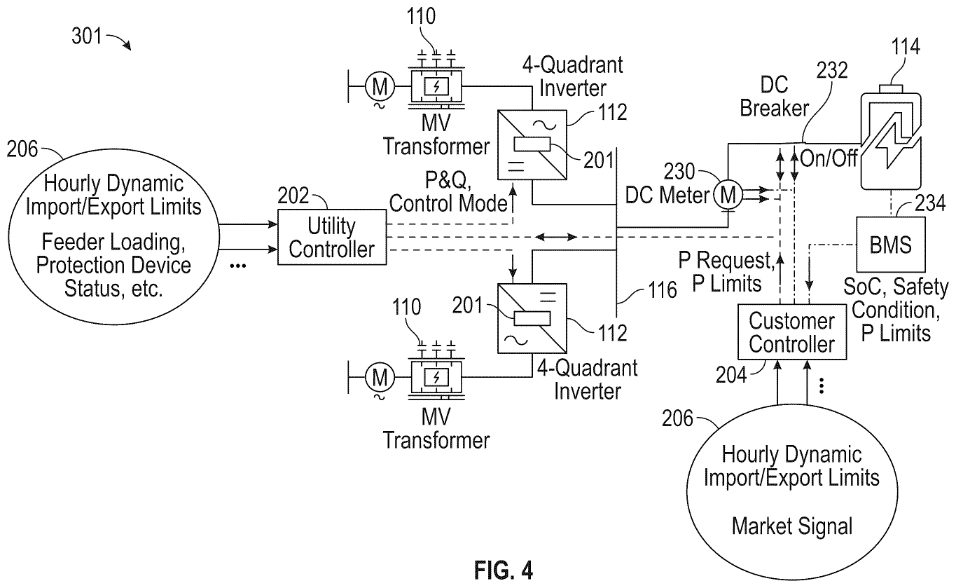

Turning now to FIG. 3, is a table 300 of operational scenarios for the energy distribution network of FIG. 1 according to one or more embodiments. The table 300 includes four operational scenarios: operational scenario 301, operational scenario 302, operational scenario 303, and operational scenario 304. The operational scenarios 301-304 are based on combinations of availability of the inverters 112, the battery 114, and the grid, as depicted in the table 300. The scenarios are described in more detail herein with reference to FIGS. 4-7.

Before the operational scenarios 301-304 are described in detail, features and functions of the customer controller 204 and the utility controller 202 are now described.

Regarding the customer controller 204, the exchange of information between the customer controller 204 and other system components is depicted in at least FIG. 4. According to one or more embodiments, the utility may send periodic (e.g., hourly, daily, etc.) import/export limits to the customer controller 204, considering a system forecast and constraints, with functionality akin to a microgrid controller (ref. IEEE Std 2030.7). According to one or more embodiments, the import/export windows includes time-of-day constraints that remain constant year-round. Within any programmed or dynamically communicated limits, a function of the customer controller 204 is to issue active power (P) generation requests (e.g., based on any pre-scheduled, or dynamic market-participation desired for the purposes of earning revenue) to the utility controller 202. The utility controller 202 subsequently undertakes inverter dispatch of active power (P) and any reactive power (Q) after considering upstream conditions (e.g., existence of faults, overloads, etc.). As such, the utility controller 202 serves to supervise dispatch commands to reduce or eliminate system violations and optimize output across the inverters. It should be appreciated that, since the battery 114 is directly connected to the DC bus 116, power output of the battery 114 is governed by the inverter dispatch controlled by the utility controller 202 once the customer controller 204 relays active power (P) requests to the utility controller 202.

Additionally, the customer controller 204 receives battery information from a battery management system (BMS) 234, such as the state of charge (SoC), state of health (SoH), and/or any active power import/export limits due to the SoC status. In situations where the utility controller 202 overrides the active power (P) requests to directly control the output of the battery 114 during contingency conditions, the customer controller 204 communicates the power import/export limits of the battery 114 to the utility controller 202 to ensure that the battery 114 is dispatched within an appropriate range. In the event of battery overheating or an internal fault, the BMS 234 communicates an indication of overheating or fault to the customer controller 204, which then trips the DC breaker 232 to isolate the battery 114.

Turning now to the utility controller 202, the control schemes and objectives of the utility controller 202 may vary based on the availability of components, such as the inverters 112 and the battery 114, and the conditions of external factors, such as hourly dynamic import/export limits, feeder loading, protection device status, and/or the like, including combinations and/or multiples thereof. Operational scenarios (e.g., the operational scenarios 301-304 of the table 300, which are organized by component availability, are now described along with the features and functionality of the utility controller 202 for each operational scenario.

Turning now to FIG. 4, the operational scenario 301 is described. In this scenario, more than one inverter (e.g., the inverters 112) and the battery 114 are available. The operational scenario 301 is considered a normal operational scenario. This scenario applies to multi-terminal energy storage systems that connect more than two feeders and have multiple inverters. According to one or more embodiments, at least two of the inverters 112 are operational in addition to the battery 114.

In this setup, since the battery 114 is available and the DC breaker 232 is closed, the battery 114 regulates voltage of the DC bus 116. The inverters 112 and the battery 114 are compatible, ensuring that the terminal voltage of the battery 114—regardless of its SoC—remains within an acceptable voltage range of the inverters 112.

The utility controller 202 actively dispatches the inverters 112 to meet the active power (P) requests from the customer, as well as facilitating power routing between feeders 104 connected to the online inverters 112. However, the control priorities may shift depending on external system conditions.

For the operational scenario 301, as shown in FIG. 4, the utility controller 202 provides the following features and functions:

Communication: The utility controller 202 provides a communication channel that interfaces with the customer controller 204 such that the utility controller 202 can receive the active power (P) requests and limits. Both the utility controller 202 and the customer controller 204 support the same communication protocol(s).

Data acquisition: The utility controller 202 is configured to receive periodic (e.g., hourly) or static import/export limits from utility SCADA or DMS (e.g., the tertiary controller 220) at each feeder's interconnection point. Additionally, the utility controller 202 is configured to receive feeder loading telemetry, the status of upstream protective elements on the feeders, and of real-time feeder energization status from the utility SCADA system via the tertiary controller 220. Controller telemetry may include one or more of status information, voltage, frequency, active power, reactive power, and timestamp data (e.g., at the levels of measurement accuracy stipulated in IEEE1547-2018, Section 4.4), and/or the like, including combinations and/or multiples thereof.

Inverter dispatch: The utility controller 202 is configured to dispatch the inverters 112 to fulfill the customer's P requests, adhering to the import/export limits of each feeder and any inverter capacity limits. The utility controller 202 may monitor the power output of the battery 114 at the DC meter 230 or any upstream AC metering, to provide proper realization of the customer P request, in addition to any Q output desired by the utility for feeder voltage management or otherwise, considering inverter losses. A Q output is a controllable value by which the inverter either injects or absorbs reactive power, or Volt-Amperes Reactive (VARs). The inverters 112 can output both active power (P) and reactive power (Q) up to their apparent power (S) limits, as indicated by their nameplate rating in kilovolt-amperes (kVA).

Power routing: The utility controller 202 is configured to manage power routing across feeders 104 when requested (e.g., by importing power from one or more feeders and exporting to others), while respecting feeder import/export limits and capacities of the inverters 112. The utility controller 202 can initiate or halt power routing based on feeder load and protective device statuses, triggered by utility-defined conditions.

Normal Conditions: Under normal operating conditions as defined by the utility (e.g., the absence of thermal overloading), if there is a conflict between power routing and P requests, the utility controller 202 can prioritize the customer's P request while using remaining capacity of the inverters 112 for power routing.

Contingency Conditions: If a feeder 104 is under contingency conditions (e.g., thermal overloading), the utility controller 202 may prioritize power routing and use any remaining capacity of the inverters 112 to satisfy the customer's P request.

Battery Utilization: If the battery 114 can be dispatched by the utility during contingency conditions (e.g., as per a utility-customer agreement), the utility controller 202 may be configured to dispatch the inverters 112 to alleviate feeder overloading by charging or discharging the battery 114 within the battery's specified P limits.

Reactive Power Control: The utility controller 202 may be configure the inverters 112 to a reactive power (Q) control mode, or other mode of operation (e.g., switching between constant reactive power, constant power factor, watt-var, and volt-var control modes). Additionally, when the inverters 112 operate in constant reactive power mode, the utility controller 202 can be configured to manage the reactive power setpoints to achieve any fixed Q output according to those received from the utility SCADA or DMS (e.g., from the tertiary controller 220).

Feeder-Level Corrections: In addition to voltage regulation on feeders 104, the utility controller 202 can be configured to implement feeder-level power factor correction and phase balancing autonomously through the onboard primary controller of the inverter, or as directed through utility SCADA controls (e.g., via the tertiary controller 220). Such capabilities can be considered lower priority actions compared to P request and power routing according to one or more embodiments.

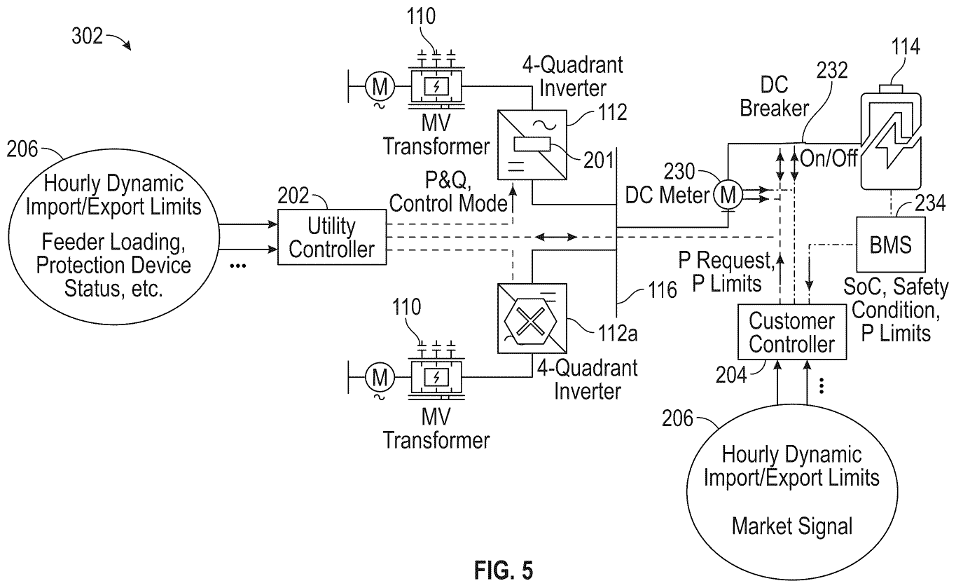

Turning now to FIG. 5, the operational scenario 302 is described. In this example, a single inverter 112 and battery 114 are available. In some situations, one or more of the inverters 112 in the multi-terminal energy storage system (e.g., the energy distribution network 100) may be tripped or taken offline (e.g., the inverter 112a is unavailable), such as due to faults on the feeder 104 or maintenance. This could lead to a situation where one inverter 112 is available in addition to the battery 114, as depicted in FIG. 5, while one or more other inverters (e.g., the inverter 112a) is unavailable. Like the operational scenario 301, the DC breaker 232 remains closed, and the battery 114 regulates voltage of the DC bus 116. Under the operational scenario 302, in addition to meeting the specifications outlined herein regarding the operational scenario 301, the utility controller 202 can be configured to fulfill the following:

Inverter Dispatch: The utility controller 202 is configured to dispatch the single available inverter to fulfill the P request as effectively as possible, within the constraints of the rating of the available inverter and considering any import/export limit at the interconnection point of the inverter.

Contingency Conditions: If the feeder 104 connected to the inverter 112 is under contingency conditions defined by the utility (e.g., thermal overloading, upstream fault, etc.), and the battery 114 is available for use during such conditions, the utility controller 202 can be configured to dispatch the inverter to alleviate system overloading as much as possible while keeping the battery output within any defined P limits.

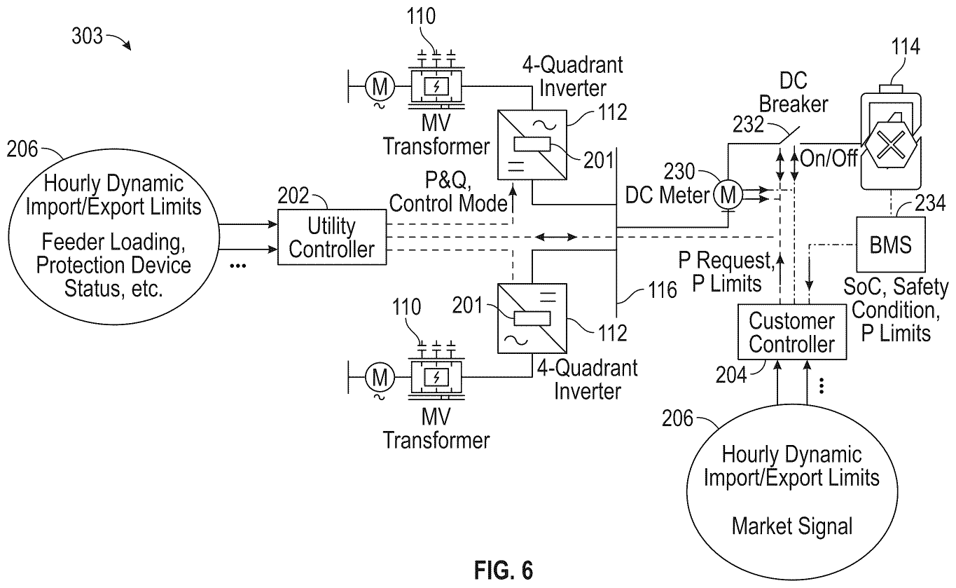

Turning now to FIG. 6, the operational scenario 303 is described. In this example, multiple of the inverters 112 are available, but the battery 114 is unavailable. The battery 114 in a multi-terminal energy storage system (e.g., the energy distribution network 100) may occasionally become unavailable, such as due to internal faults or maintenance downtime. When the battery 114 is unavailable, and if more than one of the inverters 112 are operational, power routing between different feeders 104 can still be performed through the control of the inverters 112. With the battery 114 out of service, the DC breaker 232 is open, and one of the inverters 112 regulates the voltage of the DC bus 116 while the remaining inverters 112 are dispatched by the utility controller 202 for power routing.

Under the operational scenario 303, in addition to meeting the specifications outlined herein regarding the operational scenario 301 and the operational scenario 302, the utility controller 202 can be configured to fulfill the following:

DC Bus Voltage Regulation by Inverter: The utility controller 202 can be configured to set an inverter 112 to regulate the voltage of the DC bus 216, providing an appropriate DC voltage setpoint. In such cases, the inverters 112 are configured to support at least two active power control modes: active power dispatch mode and DC voltage regulation mode.

Contingency Handling for DC Bus Voltage Regulation: If the inverter 112 regulating the voltage of the DC bus 116 is tripped or becomes unavailable, the utility controller 202 can swiftly switch to another inverter from active power dispatch mode to DC voltage regulation mode to prevent or reduce any significant deviations in DC voltage. In such cases, the inverters 112 can support on-the-fly changes in their active power control mode.

Power Routing with Multiple Inverters: Besides the inverter 112 that regulates the voltage of the DC bus 116, the utility controller 202 can dispatch the active power of the remaining inverters 112 to conduct power routing as desired, while respecting the import/export limits and the inverter capacity limits. Since the inverter 112 regulating the voltage of the DC bus 116 acts as a slack bus for DC power balancing, its active power output is dependent on the power output of the dispatched inverters 112. The power import/export from the dispatched inverters need to be controlled to ensure the inverter regulating the voltage of the DC bus 116 remains within its capacity limits.

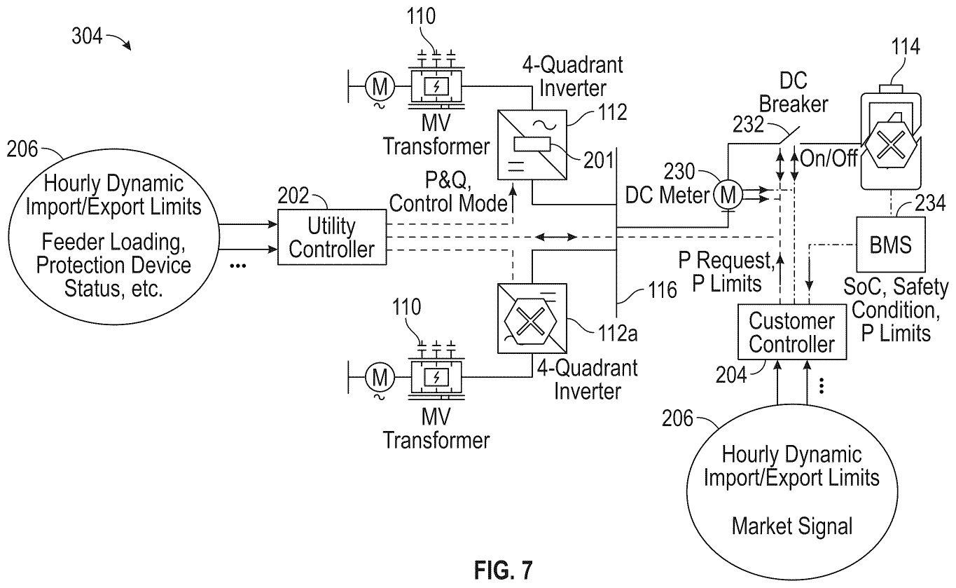

Turning now to FIG. 7, the operational scenario 304 is described. In this example, one of the inverters 112 is available (e.g., the inverter 112a is unavailable) and the battery 114 is unavailable. Unlike the operational scenario 303, in the operational scenario 304, the capability for power routing is lost, and the remaining inverter(s) 112 that is/are available is used to provide reactive power support to the feeder 104 connected to that inverter.

Under the operational scenario 304, in addition to meeting the specifications outlined herein regarding the operational scenarios 301-303, the utility controller 202 can be configured to fulfill the following:

DC Bus Voltage Regulation by Inverter: The utility controller 202 can set the active power control mode of the inverter 112 to DC voltage regulation mode, providing an appropriate DC voltage setpoint.

Reactive Power Support: The utility controller 202 can activate and deactivate the inverter 112, and to output any reactive power needed within the capacity of the inverter 112. To prevent any inadvertent energization of the area electric power system (EPS), inverters shall reenter service during reactivation as specified in IEEE 1547, sections 4.9-4.10.

In some situations, the energy distribution network 100 can transition from one operational scenario to another operational scenario. Such transitions are now described in more detail. In particular, the utility controller 202 may provide additional features and functions to provide successful transitions between the different operational scenarios 301-304.

A transition between the operational scenario 301 and the operational scenario 302 is now described. When transitioning from the operational scenario 301 to the operational scenario 302, a change in inverter availability of the inverters 112 occurs while the battery 114 is available. In the operational scenario 301 and the operational scenario 302, the battery 114 is available to regulate the voltage of the DC bus 116. When transitioning from the operational scenario 301 to the operational scenario 302, one or more of the inverters 112 may be tripped (see, e.g., FIG. 5), and the utility controller 202 responsively adjusts the power dispatch of the remaining inverter(s) to fulfill the customer's active power (P) request as effectively as possible, within the constraints of import/export limits and inverter capacity. Conversely, when moving from the operational scenario 302 to the operational scenario 301, as one or more inverters become available, the utility controller 202 can dispatch the inverters. In such cases, the utility controller 202 considers the enter service delay and power ramping requirements of the newly online inverter(s) to ensure the customer's P request is met as fully as possible during and after the inverter re-enter service process. During any transition, in accordance with IEEE 1547 section 8.1, the utility controller 202 coordinates with the area EPS operator to ensure that only intentional islanding is conducted as instructed by the utility. If an unintentional island occurs—where the distributed energy resource energizes a portion of the area EPS through the point of common coupling—the utility controller 202 should not impede any detection of the island and should ensure that the system ceases to energize the area EPS within a given time (e.g., 2 seconds) of any island formation.

A transition between the operational scenario 301 and the operational scenario 303, or a transition between the operational scenario 302 and the operational scenario 304, are now described. When transitioning from the operational scenario 301 to the operational scenario 303, or from the operational scenario 302 to the operational scenario 304, the battery 114 is disconnected by opening the DC breaker 232. Prior to this, in the operational scenarios 301 and the operational scenario 302, the battery 114 regulates the voltage of the DC bus 116. Immediately after the battery 114 is disconnected, DC voltage regulation is temporarily lost. Depending on the inverter dispatch at the moment of disconnection and the DC link capacitance in the inverter, there is a risk of severe DC voltage excursions, which could result in inverter tripping. To mitigate this risk, the utility controller switches the active power control mode of one of the inverters in the operational scenario 302 (or the single inverter in the operational scenario 304) to regulate the voltage of the DC bus 116. Furthermore, in the operational scenario 302, the utility controller 202 adjusts dispatch of the other inverters to avoid overloading the inverter that is regulating the DC voltage. In such cases, the utility controller 202 monitors the status of the DC breaker 232 and implements the change in control mode and power dispatch upon detecting the opening of the DC breaker 232.

When transitioning from the operational scenario 303 to the operational scenario 301, or from the operational scenario 304 to the operational scenario 302, the battery 114 becomes available and needs to be reconnected. However, in the operational scenario 303 and the operational scenario 304, since one inverter regulates the voltage of the DC bus 116, the voltage of the DC bus 116 may differ from the battery terminal voltage of the battery 114, posing a potential risk to the battery 114 upon reconnection. To address this, several approaches can be considered, including a simple shutdown approach and a gradual voltage adjustment approach.

The simple shutdown approach involves the utility controller 202 shutting down the inverters 112 and closing the DC breaker 232 to connect the battery 114 to the de-energized DC bus 116. Then, the available inverter(s) can be restarted with active power control set to power dispatch mode. This approach, however, results in a service interruption.

The gradual voltage adjustment approach involves the utility controller 202 monitoring both the voltage of the DC bus 116 and the battery terminal voltage of the battery 114. If the voltage difference between the voltage of the DC bus 116 and the battery terminal voltage of the battery 114 exceeds a certain threshold, the utility controller 202 adjusts the DC voltage setpoint of the inverter regulating the voltage of the DC bus 116 to bring the voltage of the DC bus 116 closer to the battery terminal voltage. Once the voltages are aligned within desirable limits, the utility controller 202 can then close the DC breaker 232. After reconnecting the battery 114, the utility controller 202 can switch the active power control mode of the inverter from regulating voltage of the DC bus 116 to power dispatch mode and adjust the power dispatch to fulfill the customer's P request. This approach avoids service interruptions but requires the utility controller to have the additional functionality of managing voltage alignment and synchronization checks.

A transition between the operational scenario 303 and the operational scenario 304 is now described, where a change in inverter 112 availability occurs while the battery 114 is unavailable. In the operational scenario 303 and the operational scenario 304, one inverter is responsible for regulating the DC bus voltage. When transitioning from the operational scenario 303 to the operational scenario 304, if certain inverters are tripped offline and the inverter currently regulating the DC bus voltage is among those tripped, the utility controller switches the control mode of one of the remaining inverter(s) to DC bus voltage regulation. If the inverter regulating the voltage of the DC bus 116 is not tripped, no action is required from the utility controller 202 during the transition.

When transitioning from the operational scenario 304 to the operational scenario 303, as one or more inverters become available and are brought back online, the utility controller 202 dispatches these newly online inverter(s), considering their enter service delay and gradual power ramping settings are followed. This ensures that the inverter regulating the voltage of the DC bus 116 continues to operate within its power limits.

According to one or more embodiments, for these transitions, the utility controller 202 complies with requirements to prevent inadvertent energization of the area EPS and ensure enter service criteria as specified in IEEE 1547, sections 4.9-4.10, as well as conforming to section 8 concerning unintentional island formation. According to one or more embodiments, the inverters 112 do not export power to any feeder 104 that is de-energized or out of service, so as to avoid operating and safety risks.

One or more of the embodiments described herein provide one or more of the following advantages.

Dynamic Load Capacity Management: Develops an advanced control system to dynamically manage and balance loads during peak demand periods, ensuring continuous power supply while preventing overloads.

Reliable Operation During Contingencies: Creates robust control mechanisms that maintain grid stability during operational disturbances by managing inverter operations and coordinating grid interactions.

Communication and Integration: Enhances grid operations through seamless communication between the utility and customer controllers, and substation SCADA systems.

Protection and Control Alignment: The system integration aligns with existing grid protection strategies and enhances fault response capabilities.

The DC-tied interconnection described herein offers a scalable solution that can adapt to multiple utility infrastructures and circuit configurations, from meshed underground network systems to overhead radial designs in a cost-effective manner, thereby enhancing overall grid resilience and reliability. One or more advantages are as follows.

Increase in Distributed Energy Hosting Capacity: Enhances the grid's capacity to accommodate more distributed energy resources without compromising stability or requiring significant infrastructure upgrades.

Potential Reductions in Interconnection Cost: DC-tied power flow control can reduce interconnection costs for distributed energy resource developers by enhancing power routing efficiency and managing power flow. These advancements minimize the need for extensive system upgrades.

Reduction in Fault Current Contributions: The proposed system can minimize fault current levels at interconnection points, thereby enhancing system safety and reducing the need for expensive protective equipment.

Enhancements to Grid Resilience: Increases the grid's ability to withstand and recover swiftly from fault conditions, preventing service interruptions and ensuring reliable energy delivery.

These and other advantages may be possible in accordance with one or more embodiments described herein.

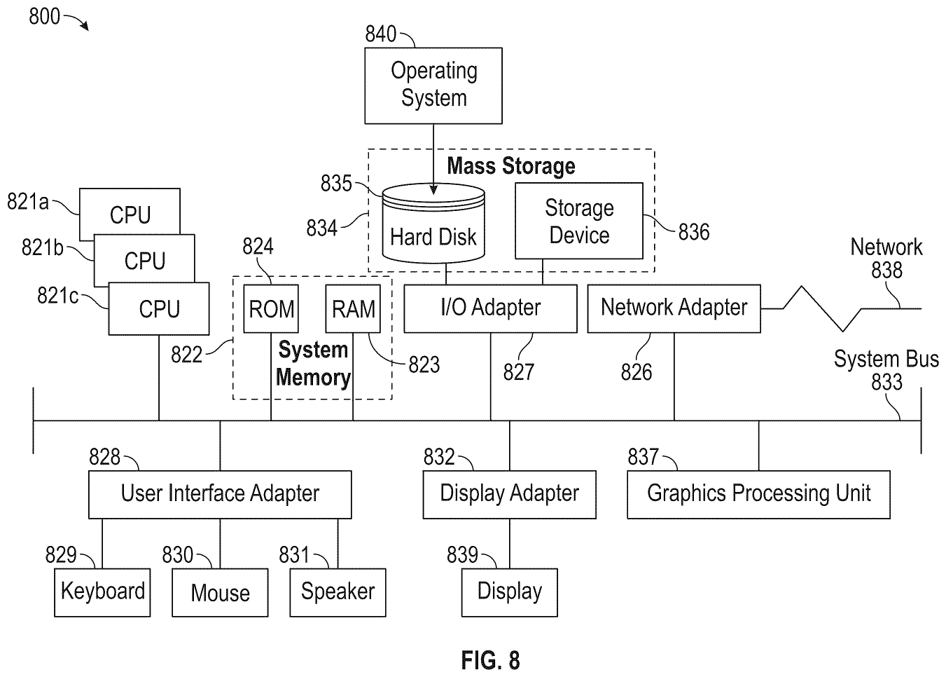

It is understood that one or more embodiments described herein is capable of being implemented in conjunction with any other type of computing environment now known or later developed. For example, FIG. 8 depicts a block diagram of a processing system 800 for implementing the techniques described herein. According to one or more embodiments, the processing system 800 is an example of the inverter controller 201, the utility controller 202, the customer controller 204, and/or the tertiary controller 220. For example, one or more of the components of the processing system 800 can be used to implement one or more of the inverter controller 201, the utility controller 202, the customer controller 204, and/or the tertiary controller 220. In accordance with one or more embodiments described herein, the processing system 800 is an example of a cloud computing node of a cloud computing environment. In examples, processing system 800 has one or more central processing units (referred to also as “processors” or “processing resources” or “processing devices”) 821a, 821b, 821c, etc. (collectively or generically referred to as processor(s) 821 and/or as processing device(s)). In aspects of the present disclosure, each processor 821 can include a reduced instruction set computer (RISC) microprocessor. Processors 821 are coupled to a system memory 822 and/or various other components via a system bus 833. The system memory 822 can include one or more temporary and/or persistent memory devices, such as a random access memory (RAM) 823, a read-only memory (ROM) 824, and/or the like, including combinations and/or multiples thereof. The system bus 833 may include a basic input/output system (BIOS), which controls certain basic functions of processing system 800.

Further depicted are an input/output (I/O) adapter 827 and a network adapter 826 coupled to system bus 833. I/O adapter 827 may be a small computer system interface (SCSI) adapter that communicates with a hard disk 835 and/or a storage device 836 or any other similar component. I/O adapter 827, hard disk 835, and storage device 836 are collectively referred to herein as mass storage 834. Operating system 840 for execution on processing system 800 may be stored in mass storage 834. The network adapter 826 interconnects system bus 833 with an outside network 838 enabling processing system 800 to communicate with other such systems.

A display (e.g., a display monitor) 839 is connected to system bus 833 by display adapter 832, which may include a graphics adapter to improve the performance of graphics intensive applications and a video controller. In one aspect of the present disclosure, adapters 826, 827, and/or 832 may be connected to one or more I/O buses that are connected to system bus 833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 833 via user interface adapter 828 and display adapter 832. A keyboard 829, mouse 830, and speaker 831 may be interconnected to system bus 833 via user interface adapter 828, which may include, for example, a Super I/O chip integrating multiple device adapters into a single integrated circuit.

In some aspects of the present disclosure, processing system 800 includes a graphics processing unit (GPU) 837. Graphics processing unit 837 is a specialized electronic circuit designed to manipulate and alter memory to accelerate the creation of images in a frame buffer intended for output to a display. In general, graphics processing unit 837 is very efficient at manipulating computer graphics and image processing, and has a highly parallel structure that makes it more effective than general-purpose CPUs for algorithms where processing of large blocks of data is done in parallel.

Thus, as configured herein, processing system 800 includes processing capability in the form of processors 821, storage capability including the system memory 822 and mass storage 834, input means such as keyboard 829 and mouse 830, and output capability including speaker 831 and display 839. In some aspects of the present disclosure, a portion of system memory 822 and mass storage 834 collectively store the operating system 840 to coordinate the functions of the various components shown in processing system 800.

The terms “about” and substantially are intended to include the degree of error associated with measurement of the particular quantity based upon the equipment available at the time of filing the application. For example, “about” or “substantially” can include a range of ±8% or 5%, or 2% of a given value.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Unless defined otherwise, any technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for controlling power flow in an energy distribution network, comprising:
a plurality of inverters, each having an inverter controller associated therewith;
a utility controller associated with a utility and configured to communicate with at least a subset of the plurality of inverters;
a customer controller associated with a customer of the utility and configured to communicate with at least the utility controller;
a direct current (DC) breaker associated with a battery of the customer; and
a DC meter of the customer, the DC meter and the DC breaker each configured to communicate with the utility controller and the customer controller,
wherein the utility controller is configured to determine a current operational scenario of the energy distribution network and to control power routing within the energy distribution network based at least in part on the current operational scenario.

2. The system of claim 1, wherein the current operational scenario is a first operational scenario in which at least two of the plurality of inverters and the battery are available.

3. The system of claim 2, wherein the battery is configured to regulate a voltage of a direct current (DC) bus of the energy distribution network during the first operational scenario.

4. The system of claim 1, wherein the current operational scenario is a second operational scenario in which one of the plurality of inverters and the battery are available.

5. The system of claim 4, wherein the utility controller is configured to dispatch the one of the plurality of inverters that is available to fulfill a power request from the customer during the second operational scenario.

6. The system of claim 1, wherein the current operational scenario is a third operational scenario in which at least two of the plurality of inverters are available and the battery is unavailable.

7. The system of claim 6, wherein one of the at least two of the plurality of inverters that are available is configured to regulate a voltage of a DC bus of the energy distribution network during the third operational scenario.

8. The system of claim 1, wherein the current operational scenario is a fourth operational scenario in which one of the plurality of inverters is available and the battery is unavailable.

9. The system of claim 8, wherein the one of the plurality of inverters that is available is configured to provide reactive power support to a feeder connected to the one of the plurality of inverters that is available during the fourth operational scenario.

10. The system of claim 1, wherein the plurality of inverters, the utility controller, and the customer controller are configured in a modular architecture that enables agile switching between operational scenarios.

11. The system of claim 10, wherein the utility controller and the customer controller are further configured to coordinate in real time to manage power flow based on component availability and grid conditions.

12. A method for controlling power flow in an energy distribution network, the energy distribution network comprising a plurality of inverters connected to a direct current (DC) bus, a battery connected to the DC bus via a DC breaker, and a utility controller associated with a utility and in communication with the plurality of inverters and the DC breaker, the method comprising:
determining, by the utility controller, a current operational scenario based at least in part on availability of one or more of the plurality of inverters and the battery;
controlling, by the utility controller, power routing within the energy distribution network based at least in part on the current operational scenario;
regulating, by the utility controller, a voltage of the DC bus based at least in part on the current operational scenario; and
coordinating, by the utility controller, operation of the plurality of inverters and the battery to manage power flow in the energy distribution network.

13. The method of claim 12, further comprising communicating, by the utility controller, with a customer controller associated with a customer of the utility to receive power requests, battery status information, and DC breaker status information.

14. The method of claim 13, wherein controlling power routing comprises dispatching at least one of the plurality of inverters to fulfill a power request from the customer while respecting feeder import and export limits.

15. The method of claim 12, wherein determining the current operational scenario comprises determining a number of the plurality of inverters that are available and determining whether the battery is available.

16. The method of claim 12, wherein the energy distribution network further comprises a customer controller associated with a customer of the utility and a tertiary controller,
wherein the customer controller is configured to communicate with the utility controller and the DC breaker, to receive battery status information and power requests from the customer, and to relay the battery status information and the power requests to the utility controller, and
wherein the tertiary controller is configured to communicate with the utility controller and the customer controller, the tertiary controller being operable to issue commands to the utility controller and the customer controller to orchestrate resource operation and optimize system performance across the energy distribution network.

17. The method of claim 12, further comprising, during a transition between two different operational scenarios, adjusting a control mode of at least one inverter of the plurality of inverters to regulate the voltage of the DC bus.

18. The method of claim 12, further comprising monitoring, by the utility controller, a status of the DC breaker and adjusting a power dispatch in response to the DC breaker opening or closing.

19. The method of claim 12, further comprising providing, by the utility controller, reactive power support to a feeder connected to an available inverter of the plurality of inverters during an operational scenario in which the battery is unavailable.

20. An energy distribution network comprising:
a plurality of four-quadrant inverters, each having an inverter controller and being connected to a direct current (DC) bus;
a battery connected to the DC bus via a DC breaker and a DC meter;
a utility controller associated with a utility, the utility controller configured to communicate with at least a subset of the plurality of four-quadrant inverters, the DC breaker, and a DC meter, to determine a current operational scenario of the energy distribution network based at least in part on availability of the plurality of four-quadrant inverters and the battery, to control power routing and regulate a voltage of the DC bus based on the current operational scenario, and to coordinate operation of the plurality of four-quadrant inverters and the battery to manage power flow within the energy distribution network via optimal power routing for enhanced hosting capacity and improving feeder rating objectives, thereby optimizing performance across the energy distribution network;
a customer controller associated with a customer of the utility, the customer controller configured to communicate with the utility controller, the DC breaker, and the DC meter, to receive battery status information and power requests from the customer, and to relay the battery status information and the power requests to the utility controller; and
a tertiary controller configured to communicate with the utility controller and the customer controller, the tertiary controller being operable to issue commands to the utility controller and the customer controller to orchestrate resource operation and optimize system performance across the energy distribution network,
wherein the utility controller, the customer controller, and the tertiary controller are configured to coordinate in real time to manage the power flow, component availability, and grid conditions within the energy distribution network.
